(19) United States
(12) Patent Application Publication
(10) Pub. No.: US 2026/0025756 A1
(43) Pub. Date: Jan. 22, 2026

(54) LOW-POWER WAKE UP SIGNAL ASSOCIATED WITH DRX

(71) Applicant: InterDigital Patent Holdings, Inc., Wilmington, DE (US)

(72) Inventors: Yifan Li, Conshohocken, PA (US); Guodong Zhang, Woodbury, NY (US); Virgile Garcia, Antibes (FR); Ravikumar Pragada, Warrington, PA (US); Pascal Adjakple, Great Neck, NY (US); Patrick Cabrol, Bayshore, NY (US)

(73) Assignee: InterDigital Patent Holdings, Inc., Wilmington, DE (US)

(21) Appl. No.: 19/116,611

(22) PCT Filed: Sep. 29, 2023
(86) PCT No.: PCT/US2023/034126

§ 371 Date: Mar. 28, 2025

Related U.S. Application Data
(60) Provisional application No. 63/411,457, filed on Sep. 29, 2022.

(51) Int. Cl. H04W 52/02; H04W 72/232; H04W 76/27; H04W 76/28

(52) U.S. Cl. CPC H04W 52/0216; H04W 52/0235; H04W 72/232; H04W 76/27; H04W 76/28

(57) ABSTRACT

Described herein are systems, methods and instrumentalities associated with power saving in a wireless communication system. A wireless transmit/receive unit (WTRU) in the system may receive configuration information regarding a discontinuous reception (DRX) mode and a low-power wake-up signal (WUS). The WTRU may enter the DRX mode and monitor for the low-power WUS. The WTRU may determine whether to wake up during an on duration of the DRX mode based on whether the low-power WUS is received or based on information included in the low-power WUS.

### CROSS-REFERENCE TO RELATED APPLICATIONS

This application claims the benefit of Provisional U.S. Patent Application No. 63/411,457, filed Sep. 29, 2022, the disclosure of which is incorporated herein by reference in its entirety.

### BACKGROUND

In wireless communication technologies such as cellular and WLAN, radio frequency (RF) front-ends may include a mixture of passive and active components. For example, the passive components may include Rx antennas, Tx/Rx path switches, and/or filters, which may use little if any power to function. On the other hand, the active components may include an oscillator to tune to a carrier frequency, a low noise amplifier, and/or an A/D converter (e.g., in the Rx path), which may require more power to function.

### SUMMARY

Disclosed herein are systems, methods, and instrumentalities associated with a wireless communication system. According to embodiments of the present disclosure, a wireless transmit/receive unit (WTRU) may enter a discontinuous reception (DRX) mode (e.g., such as a connected DRX mode) and monitor for a first signal while in the DRX mode. Based on a determination that the first signal has been received and that the first signal indicates that the WTRU is to monitor for a second signal, the WTRU may further monitor for the second signal while in the DRX mode (e.g., by activating a receiver configured to receive the second signal). If the WTRU determines that the second signal has been received and that the second signal indicates that the WTRU is to monitor for downlink control information (DCI), the WTRU may receive the DCI and decode the DCI.

The first signal described herein may be associated with a lower power consumption than the second signal. In some examples, the first signal may be associated with a first WTRU group, the second signal may be associated with a second WTRU group, and the first WTRU group may include more WTRUs than the second WTRU group (e.g., the WTRU may belong to both the first WTRU group and the second WTRU group). In some examples, the first signal may be a signal transmitted to a WTRU group comprising the WTRU, and the second signal may be a signal transmitted specifically to the WTRU. In some examples, the WTRU may further receive configuration information that may indicate one or more time positions for the WTRU to monitor for the first signal.

In some examples, if the WTRU determines that the first signal has not been received or that the first signal includes no indication for the WTRU to monitor for the second signal, the WTRU may sleep through a subsequent DRX on duration. Similarly, if the WTRU determines that the second signal has not been received or that the second signal includes no indication for the WTRU to monitor for the DCI, the WTRU may also sleep through a subsequent DRX on duration.

According to embodiments of the present disclosure, a network device such as a base station may transmit a first signal to a WTRU while the WTRU is in a DRX mode, wherein the first signal may indicate whether the WTRU is to monitor for a second signal. If the first signal indicates that the WTRU is to monitor for the second signal, the network device may further transmit a second signal to the WTRU while the WTRU is in the DRX mode, wherein the second signal may indicate that the WTRU is to monitor for downlink control information (DCI). The network device may subsequently transmit the DCI to the WTRU. In examples, the first signal transmitted by the network device may be associated with a power consumption that is lower than a power consumption associated with the second signal. In examples, the first signal may be associated with a first WTRU group that includes the WTRU, the second signal may be associated with a second WTRU group that includes the WTRU, and the first WTRU group may include more WTRUs than the second WTRU group. In examples, the first signal may be transmitted by the network device to a WTRU group comprising the WTRU, and the second signal may be transmitted by the network device specifically to the WTRU. In examples, the network device may further transmit, to the WTRU, configuration information that may indicate one or more time positions for the WTRU to monitor for the first signal.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of a low power (LP) wake-up signal (WUS) that may be used for a DRX mode.

FIG. 3 is a flow diagram illustrating an example of determining whether to wake up a main receiver chain based on whether an LP WUS is detected.

FIG. 4 is a flow diagram illustrating an example of determining whether to wake up a main receiver chain based on information carried by an LP WUS.

FIG. 5 is a diagram illustrating an example of refining synchronization and receiving transmission based on an LP WUS.

FIG. 6 is a flow diagram illustrating an example of determining whether to wake up a main receiver chain based on an identifier carried by an LP WUS.

FIG. 7 is a diagram illustrating an example of an LP WUS that may carry a PDCCH monitoring occasion index.

FIG. 8 is a flow diagram illustrating an example of determining whether to wake up a main receiver chain and determining a PDCCH monitoring occasion based on an LP WUS.

FIG. 9 is a diagram illustrating an example of a call flow associated with determining a WUS for cDRX.

FIG. 10 is a diagram illustrating an example of a call flow associated with determining a WUS for cDRX based on assistance information provided by a WTRU.

FIG. 11 is a diagram illustrating an example of a call flow associated with autonomously determining a WUS for cDRX.

FIG. 12 is a diagram illustrating an example of a call flow associated with selecting a WUS for cDRX based on assistance information provided by a base station.

FIG. 13 is a flow diagram illustrating an example of determining whether to wake up a main receiver chain based on an LP WUS and/or a legacy WUS.

FIG. 14 is a diagram illustrating an example of a call flow associated with autonomously determining a WUS for cDRX.

FIG. 15 is a diagram illustrating an example of a call flow associated with determining a WUS for cDRX based on assistance information provided by a base station.

FIG. 16 is a diagram illustrating an example of a multi-stage wake-up procedure.

FIG. 17 is a flow diagram illustrating an example of determining whether to wake up a main receiver chain based on a multi-stage wake-up procedure.

FIG. 18 is a flow diagram illustrating an example of determining whether to wake up a main receiver chain based on a multi-stage wake-up procedure.

### DETAILED DESCRIPITION

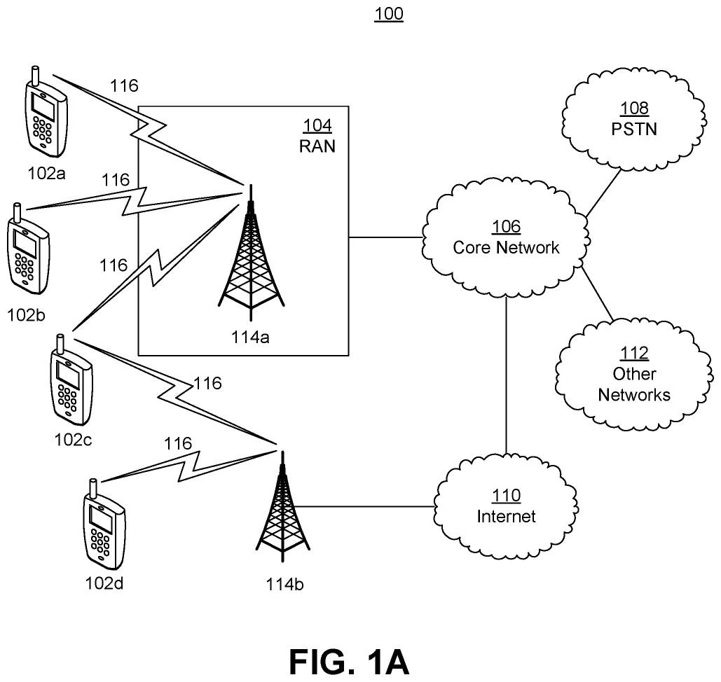

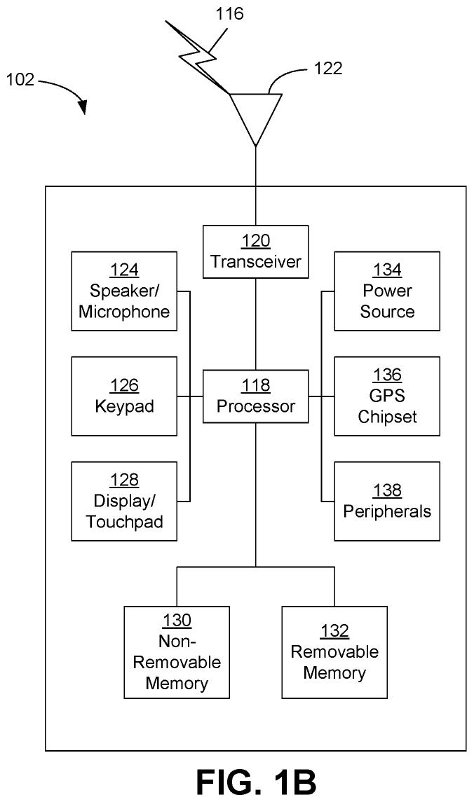

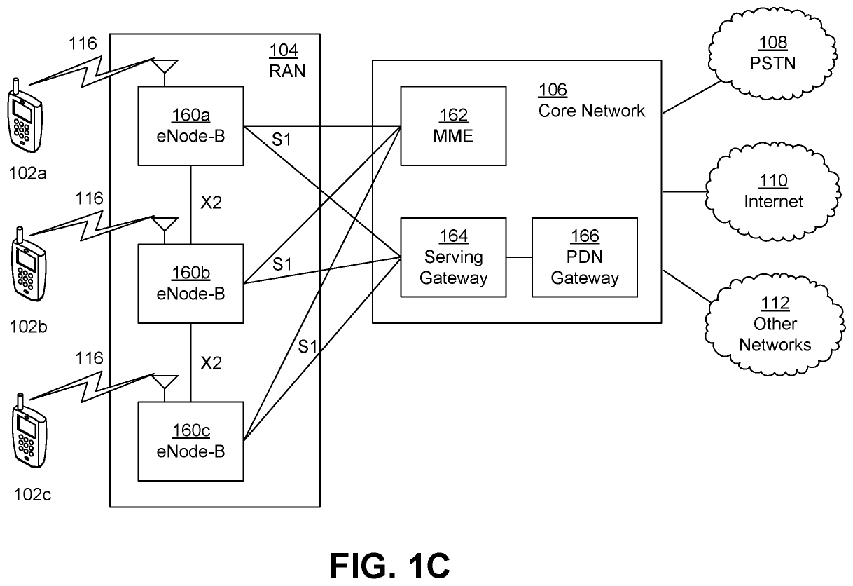

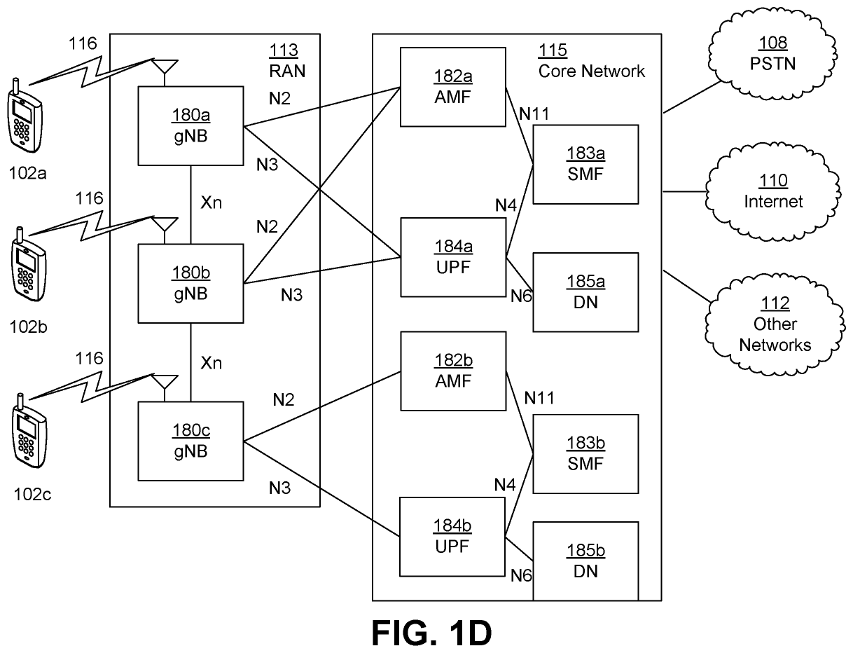

FIG. 1A is a diagram illustrating an example communications system 100 in which one or more disclosed embodiments may be implemented. . The communications system 100 may be a multiple access system that provides content, such as voice, data, video, messaging, broadcast, etc., to multiple wireless users. . The communications system 100 may enable multiple wireless users to access such content through the sharing of system resources, including wireless bandwidth. . For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. . By way of example, the base stations 114a, 114b may be a base transceiver station (BTS), a Node-B, an eNode B (eNB), a Home Node B, a Home eNode B, a gNode B (base station), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a base station).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include base stations 180a, 180b, 180c, though it will be appreciated that the RAN 113 may include any number of base stations while remaining consistent with an embodiment. The base stations 180a, 180b, 180c may each include one or more transceivers for communicating with the WTRUs 102a, 102b, 102c over the air interface 116. In one embodiment, the base stations 180a, 180b, 180c may implement MIMO technology. For example, base stations 180a, 108b may utilize beamforming to transmit signals to and/or receive signals from the base stations 180a, 180b, 180c. Thus, the base station 180a, for example, may use multiple antennas to transmit wireless signals to, and/or receive wireless signals from, the WTRU 102a. In an embodiment, the base stations 180a, 180b, 180c may implement carrier aggregation technology. For example, the base station 180a may transmit multiple component carriers to the WTRU 102a (not shown). A subset of these component carriers may be on unlicensed spectrum while the remaining component carriers may be on licensed spectrum. In an embodiment, the base stations 180a, 180b, 180c may implement Coordinated Multi-Point (COMP) technology. For example, WTRU 102a may receive coordinated transmissions from base station 180a and base station 180b (and/or base station 180c).

The WTRUs 102a, 102b, 102c may communicate with base stations 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with base stations 180a, 180b, 180c using subframe or transmission time intervals (TTIs) of various or scalable lengths (e.g., containing varying number of OFDM symbols and/or lasting varying lengths of absolute time).

The base stations 180a, 180b, 180c may be configured to communicate with the WTRUs 102a, 102b, 102c in a standalone configuration and/or a non-standalone configuration. In the standalone configuration, WTRUs 102a, 102b, 102c may communicate with base stations 180a, 180b, 180c without also accessing other RANs (e.g., such as eNode-Bs 160a, 160b, 160c). In the standalone configuration, WTRUs 102a, 102b, 102c may utilize one or more of base stations 180a, 180b, 180c as a mobility anchor point. In the standalone configuration, WTRUs 102a, 102b, 102c may communicate with base stations 180a, 180b, 180c using signals in an unlicensed band. In a non-standalone configuration WTRUs 102a, 102b, 102c may communicate with/connect to base stations 180a, 180b, 180c while also communicating with/connecting to another RAN such as eNode-Bs 160a, 160b, 160c. For example, WTRUs 102a, 102b, 102c may implement DC principles to communicate with one or more base stations 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and base stations 180a, 180b, 180c may provide additional coverage and/or throughput for servicing WTRUs 102a, 102b, 102c.

Each of the base stations 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the base stations 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the base stations 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In wireless communication technologies such as cellular and WLAN, RF front ends may include a mixture of passive and active components. For example, the passive components may include Rx antennas, transmission (Tx)/reception (Rx) path switches, and/or filters that may use little if any power to function, while the active components may include an oscillator to tune to a carrier frequency, a low noise amplifier, and/or an A/D converter (e.g., in the Rx path), which may use more power to function.

Advances in RF component design over the past years have made it possible to use a type of RF circuitry capable of processing RF waveforms received through an antenna front-end of a receiving device in a low power mode (e.g., an ultra-low power (ULP) mode with minimal usage of or even without an active power supply). For example, such a receiving device may consider (e.g., only) passive RF components and may harvest energy from the received RF waveform to process the signal carried by the waveform. Another example may be to use a mixer-first architecture, eliminate an RF low noise amplifier (LNA), and focus on the development of passive RF components. Passive (e.g., substantially passive) ULP receivers may use RF components such as cascading capacitors, zero-bias Schottky diodes or micro-electromechanical systems (MEMS) to implement the functionality associated with voltage multipliers or rectifiers, charge pumps, and/or signal detectors. Multiple (e.g., two) types of modulation schemes such as On-Off Keying (OOK) and Frequency-Shift Keying (FSK), may be used in ULP receivers (e.g., OOK may be selected due to its simplicity).

A wake-up signal (WUS) and/or a paging early indication (PEI) may be used in a wireless communication system. DCI-based WUS design may involve using a DCI format (e.g., such as DCI format 2_6) to indicate a WUS for a WTRU in an RRC_Connected state, whereas DCI-based PEI design may involve using a DCI format (e.g., such as DCI format 2_7) to indicate paging and/or tracking reference signal (TRS) availability for one or more WTRUs in an RRC_IDLE or INACTIVE state. A DCI (e.g., of format 2_7) may carry a paging early indication, such as, e.g., a bitmap, for multiple (e.g., up to 8) subgroups per paging opportunity (PO). The DCI may be associated with multiple (e.g., up to 8) POs (e.g., each bit in the bit map may be associated with a subgroup within one of the associated POs). The WTRU may monitor the DCI (e.g., of format 2_7), and if the WTRU determines that a bit corresponding to a subgroup within a PO is set to ‘1’, the WTRU may monitor for a paging message or a TRS during the PO. Otherwise, the WTRU may not monitor for a message or signal during the PO.

In a wireless communication system, a device such as an enhanced mobile broadband (eMBB) device may spend over 80% of its energy when operating in an RRC connected state (e.g., the energy may be used for control channel monitoring, data transmission/reception, other periodic activities, etc.). Improving the power efficiency of such a device in the RRC connected state may extend the battery life of the device and/or improve user experiences.

A WUS may be employed during a DRX mode such as a connected DRX (cDRX) mode for power saving. Such a WUS may be received by a WTRU through a regular RF receiver or chain, or through a low-power (LP) receiver such as an LP wake-up receiver (e.g., the LP receiver may consume less power than the regular receiver). Receiving an LP WUS via the LP receiver may consume less power (e.g., 100 times lower compared to using a main radio to receive a WUS), thus achieving higher power saving. Such an LP WUS may be adopted for cDRX (e.g., in an RRC connected state). Time and/or frequency resources may be allocated (e.g., via RRC signaling, an MAC CE, DCI, etc.) for using the LP WUS during the cDRX. These resources may include a time domain resource associated with receiving the LP WUS via adjacent transmissions, a time domain resource associated with receiving the LP WUS within a time gap before a cDRX on duration, a frequency domain resource associated with receiving the LP WUS within the same bandwidth part (BWP) using for the cDRX, a frequency domain resource associated with receiving the LP WUS within a dedicated BWP, a frequency domain resource associated with receiving the LP WUS in a frequency region that may be within the BWP used for the cDRX, etc.

An LP capable WTRU configured to use an LP WUS (e.g., while in a cDRX mode) may perform one or more of the following operations. The WTRU may determine whether to wake up its main receiver chain based on whether the LP WUS is detected. The WTRU may determine whether to wake up its main receiver chain based on an indication (e.g., a flag bit) carried by the LP WUS. The WTRU may determine whether to wake up its main receiver chain based on additional information carried by the LP WUS. A re-synchronization procedure may be performed when the WTRU wakes up a main receiver based on an LP WUS (e.g., received via an LP receiver).

When referred to herein, a wake-up signal (WUS) may include any message received by a WTRU that may cause the WTRU to receive (or transmit) additional messages or information. When referred to herein, a regular or legacy WUS may include a WUS received using a regular-powered receiver (e.g., a main receiver) of the WTRU, and an LP WUS may include a WUS received using an LP receiver of the WTRU (e.g., the LP receiver may consume less power than the main receiver when receiving a signal, and may be implemented through a separate RF chain than the RF chain associated with the main receiver). If an LP capable WTRU is configured to use an LP WUS and/or a legacy WUS (e.g., during cDRX), a network device such as a base station may decide which WUS is to be used, or the WTRU itself may determine which WUS is to be used. The WTRU may be configured to monitor for the LP WUS by default and monitor for the legacy WUS as a backup option (e.g., when the WTRU is unable to detect the LP WUS due to coverage issues, blockage, interference, etc.).

The term “low power” (LP) may be used interchangeably herein with the term “ultra-low power” (ULP), for example, as in an LP/ULP signal, an LP/ULP WUS, an LP/ULP receiver, an LP/ULP capable WTRU, an LP/ULP WUS for cDRX, etc. An LP or ULP signal (e.g., including an LP or ULP WUS) may include a signal intended for a low-power or ultra-low-power receiver. The signal may be transmitted by a base station (e.g., a gNB) or a user equipment (UE) such as a WTRU. The signal may be received using an LP or ULP receiver. The LP or ULP receiver (e.g., separate from a main receiver) may have the ability to monitor for and/or receive a signal (e.g., a wake-up signal, which may include a small payload) with lower power consumption than a regular receiver (e.g., the main receiver). The regular (e.g., main) receiver, which may be configured for data transmission and reception during normal operation, may be turned off or set to sleep (e.g., deactivate) until it is turned on (e.g., activated) based on a wake-up signal received via the low-power receiver. A LP or ULP capable WTRU may be a WTRU equipped with an LP or ULP receiver and/or capable of receiving an LP or ULP signal. A legacy WTRU may be a WTRU that may not be equipped with an LP or ULP receiver, or may not be capable of receiving an LP or ULP signal. The term “WTRU” and the term “LP/ULP capable WTRU” may be used interchangeably in some examples provided herein.

Examples may be described herein in the context of a cDRX mode, but those skilled in the art will appreciate that the techniques and/or procedures described herein may also be applicable to other DRX modes including, for example, a DRX mode associated with an RRC_IDLE state.

A WTRU may be configured to enter a DRX mode (e.g., for saving power) while in an RRC connected state (e.g., if the WTRU has no activity for a while). The WTRU may wake up during a DRX on duration, for example, to monitor for and decode (e.g., blindly decode) a message (e.g., a scheduling DCI) to determine if the network (e.g., a gNB) has DL data for the WTRU. The WTRU may stay in a sleeping mode during a DRX off duration and assume that the network does not send data to the WTRU during the DRX off duration.

An LP capable WTRU may be configured to use (e.g., jointly) an LP WUS and a legacy WUS (e.g., while in a cDRX mode). The WTRU may perform a multi-stage (e.g., two-stage) wake-up procedure based on an LP WUS and a legacy WUS, or based on two LP WUSes. The WTRU may use the multi-stage wake-up procedure during the cDRX mode to further save power. An LP WUS receive by the WTRU may include an indication of whether there is a DCI targeted for the WTRU (e.g., which the WTRU may receive during a DRX on duration). If no LP WUS is received or that a received LP WUS indicates that no DCI is targeted for the WTRU, the WTRU may keep on sleeping (e.g., not waking up its main receiver chain for signal reception and/or decoding). The LP WUS may be a group common or group based LP WUS, or a WTRU specific LP WUS. With the LP WUS, the WTRU may avoid unnecessarily waking up a main radio (e.g., for PDCCH reception and/or decoding), therefore further improving the power efficiency of the WTRU.

When referred to herein, a WTRU skipping a DRX on duration may mean that the WTRU may perform one or more of the following actions in any combination or order. The WTRU may turn off the main receiver if the main receiver has already been turned on. The WTRU may keep the main receiver off if the main receiver is currently turned off. The WTRU may go into a sleep mode (e.g., a deep sleep mode) or another power saving mode such as, e.g., a macro sleep mode, if the main receiver has already been turned on. The WTRU may remain in the sleep mode or the other power saving mode (e.g., the macro sleep mode) if the main receiver has already entered that mode. The WTRU may not monitor for a signal (e.g., a PDCCH transmission) during the next DRX cycle (e.g., during the next DRX on duration).

When referred to herein, a WTRU waking up in a DRX on duration may mean that the WTRU may perform one or more of the following actions in any combination or order. The WTRU may monitor a PDCCH during the next DRX cycle including, for example, the next DRX on duration. The WTRU may wake up its main receiver chain ahead of the next DRX cycle. The WTRU may wake up its main receiver in the next DRX cycle (e.g., in the next DRX on duration).

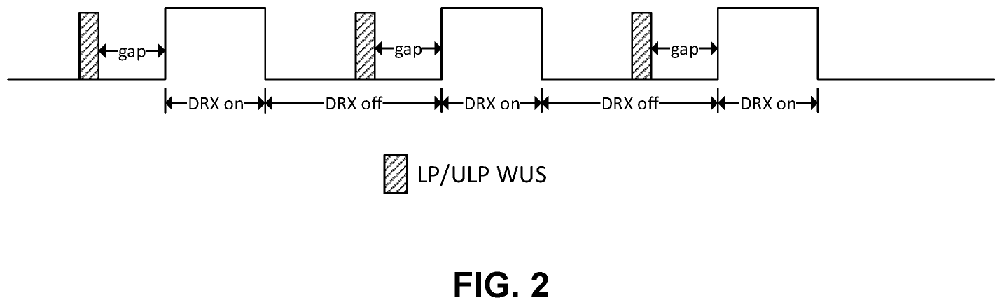

In examples, an LP capable WTRU may use (e.g., only use) an LP WUS and not use a legacy WUS while in a DRX mode (e.g., while in a cDRX mode). For instance, while the LP capable WTRU is in the DRX mode, the WTRU may monitor (e.g., only monitor) for an LP WUS to determine whether the WTRU may wake up its main receiver in the next DRX on duration. The LP WUS may be transmitted by a transmitter (e.g., a network device) before an DRX on duration, as shown in FIG. 2. The LP capable WTRU may monitor for (e.g., as a first procedure) the LP WUS to determine whether there is a DCI (e.g., a DCI scheduling a transmission) targeted for the WTRU that the WTRU may receive in the DRX on duration (e.g., the DRX on duration following the LP WUS transmission). The WTRU may keep an LP receiver turned on (e.g., activated) to monitor (e.g., continuously monitor) for the LP WUS, or the WTRU may turn on the LP receiver before the DRX on duration. The WTRU may be configured (e.g., via RRC signaling) with a time window to receive the LP WUS, or the WTRU may know (e.g., be preconfigured with) the time of the LP WUS transmission. With the LP-WUS, the DRX (e.g., cDRX operations) of the WTRU may be configured more aggressively. For example, an ultra-short DRX configuration may be introduced for the cDRX mode when an LP-WUS is used such that the cDRX may have shorter DRX cycles (e.g., short and/or long DRX cycles) than a cDRX mode without the LP-WUS.

The LP capable WTRU may determine the time and/or frequency location for detecting an LP WUS. With respect to the time location, the LP WUS may be transmitted at a time location adjacent to the start of a DRX on duration. With such a design, the WTRU may be able to process the LP WUS signal and wake up its main receiver chain in a back-to-back manner. For instance, a time gap may be implemented between the LP WUS arrival time and the start of the DRX on duration, and the WTRU may be configured with or informed about (e.g., via signaling from a network such as RRC signaling) the time gap for receiving the LP WUS transmission. The time position of the LP WUS may be included as part of an RRC configuration for the LP WUS. The WTRU may be configured with a relative location of the LP WUS with respect to a subsequent DRX on duration (e.g., with respect to the starting symbol and/or starting slot of the LP WUS relative to that of the DRX on duration). The WTRU may be configured with a time gap between the starting or the ending point of the LP WUS with respect to another reference point.

The time location or time gap described herein may be specified (e.g., explicitly) in terms of slots, symbols, or both slots and symbols. The time location or time gap may be configured via predefined codepoints. Multiple time locations or time gaps may be predefined as different combinations of slots and/or symbols, and a network may signal (e.g., via RRC configuration information, a MAC CE, or DCI) one of the combinations (e.g., using coded bits) for a WTRU to use. The starting point of a DRX on duration may be used as a reference point for determining the time location for monitoring an LP WUS. The reference point may be the boundary of a slot, a frame, or a subframe associated with the starting point of the DRX on duration. When such a boundary is used as the reference point, the LP WUS may be transmitted after the reference point. For example, when a frame boundary is used as the reference point, the LP WUS may be transmitted T_{gap} after the frame boundary, where T_{gap} may represent a configured time gap (e.g., the LP WUS may be transmitted in slot 2 of the frame while the DRX on duration may start from slot 4).

The time location of an LP WUS may be known to a WTRU if the network (e.g., a gNB) transmits a configuration associated with the LP WUS to the WTRU. Upon receiving the configuration, the WTRU may monitor for and detect the LP WUS in the configured time location. The time location of the LP WUS may be configured as a time range, in which case the LP WUS may be transmitted by the network and detected (e.g., blindly detected) by the WTRU in any location within the range. The WTRU may receive configuration information (e.g., via RRC signaling) regarding an LP WUS window (e.g., a window for monitoring for an LP WUS). The configuration information may indicate the duration of the LP WUS window (e.g., in units of us/ms, symbols, slots, subframes, etc.) and/or the starting point of the LP WUS window. In examples, the WTRU may be configured with (e.g., informed of) an absolute time location of an LP WUS transmission. For example, the WTRU may receive an explicit indication from the network about the slot number, symbol number, etc. in which the WTRU may monitor for and detect an LP WUS.

An LP WUS may be transmitted in band or out of band with respect to a frequency band associated with a cDRX mode. In the case of in band transmission, the LP WUS may be transmitted (e.g., the WTRU may receive the LP WUS) using the same frequency band associated with the cDRX (e.g., within the same bandwidth part (BWP) used by the WTRU while in the cDRX mode), and/or using the same subcarrier spacing (SCS) associated with the cDRX. In the case of out of band transmission, the LP WUS may be transmitted in a separate BWP or frequency region from that associated with the cDRX, and/or using a different SCS from that associated the cDRX.

A WTRU may be configured with a frequency location for detecting an LP WUS (e.g., within a BWP or frequency region associated with the LP WUS). The frequency location may be a frequency range, which may be an entire BWP or frequency region associated with the LP WUS, or a portion of the BWP or frequency region associated with the LP WUS (e.g., the frequency range may fall within the BWP or frequency region configured for the LP WUS). The frequency location of the LP WUS may be configured as an exact frequency location (e.g., based on the smallest unit of frequency that may be allocated and/or used). The frequency location of the LP WUS may be configured as a frequency offset and/or a frequency size. For example, the WTRU may be configured with a frequency offset with respect to the lowest resource block (RB) of the BWP or frequency region associated with the LP WUS. The frequency offset may be specified in unit of RBs and/or resource elements (REs). The size (or length) of the frequency location may also be specified in unit of RBs and/or REs.

A WTRU may monitor for and detect an LP WUS in one or more configured resources (e.g., at one or more configured time and/or frequency locations of the LP WUS). If a particular time/frequency location is configured, the WTRU may detect the LP WUS at that location. If a time/frequency range or region is configured, the WTRU may detect (e.g., blindly detect) the LP WUS within the range or region.

An LP WUS may be transmitted in a WTRU-specific manner or in a group common manner. If the LP WUS is transmitted in the WTRU specific manner, the LP WUS may be intended for a target WTRU (e.g., an LP WUS capable WTRU), which may determine whether to wake up its main receiver chain (e.g., during a DRX on duration) by monitoring for the LP WUS. If the LP WUS is transmitted in a group common manner, the LP WUS may be intended for a group of WTRUs, which may determine whether to wake up their respective main receiver chains (e.g., during a DRX on duration) by monitoring for the LP WUS and/or decoding additional information carried by the ULP WUS.

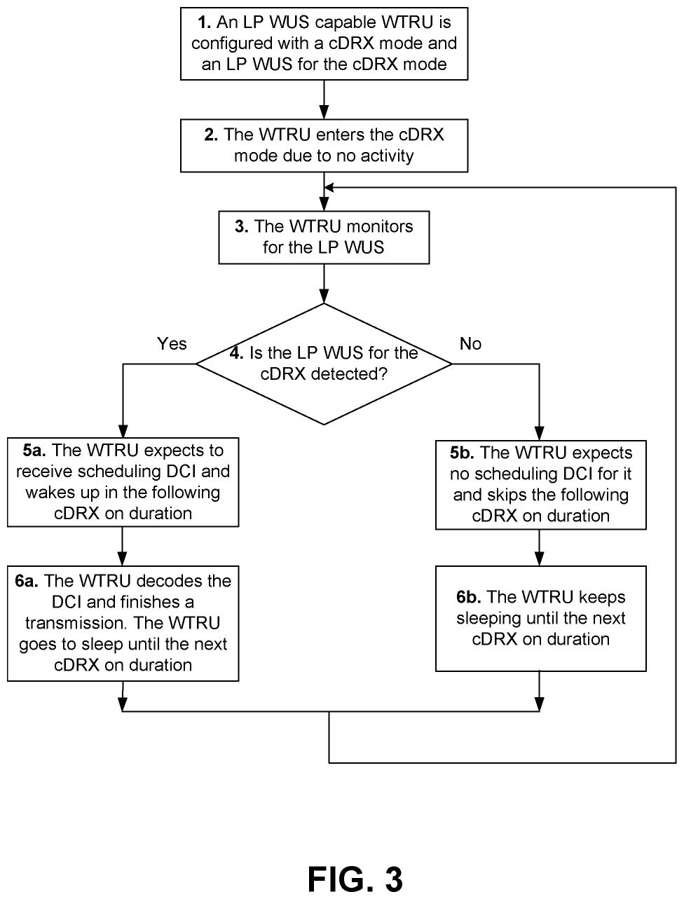

A WTRU may use various techniques to determine whether it should wake up its main receiver chain. For example, the WTRU may determine whether to wake up its main receiver chain based on whether an LP WUS is received. The WTRU may monitor for the LP WUS and, if the LP WUS is detected, the WTRU may wake up its main receiver chain (e,g., to receive an additional signal) in the following DRX on duration. If the WTRU receives no LP WUS, it may skip the following DRX on duration (e.g., keep the main receiver sleeping during the on cycle). FIG. 3 illustrates an example that may include one or more of the following operations or procedures.

At 1, an LP capable WTRU operating in an RRC connected state may enter a cDRX mode. The WTRU may be configured with (e.g., receive configuration information for) the cDRX mode and/or an LP WUS associated with the cDRX mode. At 2, the WTRU may trigger an inactivity timer if there is no transmission or reception (e.g., if there is no PDCCH scheduling or indicating a transmission). The inactivity timer may be restarted if the WTRU subsequently receives a PDCCH scheduling a transmission. Upon the expiration of the inactivity timer, the WTRU may enter the cDRX mode.

At 3, the WTRU may keep its main receiver chain sleeping (e.g., keep the main receiver in a deep sleep mode or turn off the main receiver), while using an LP receiver to monitor for an LP WUS (e.g., to save power). The WTRU may keep the LP receiver on (e.g., always on) while the WTRU is in the cDRX mode. The WTRU may also turn on the LP receiver based on an indication to detect the LP WUS (e.g., based on a configured time/frequency location for detecting the LP WUS). The WTRU may detect the LP WUS at a configured resource location or blindly detect the LP WUS within a configured resource range or region.

At 4, the WTRU may determine if it has detected an LP WUS (e.g., before a cDRX on duration). If the WTRU has detected the LP WUS, it may go to 5a. If the WTRU has not detect the LP WUS, it may go to 5b. At 5a (e.g., if the WTRU detects the LP WUS), the WTRU may expect a PDCCH in the following DRX on duration that may indicate (e.g., schedule) a transmission, and the WTRU may wake up the main receiver chain to receive the PDCCH. If a WTRU-specific LP WUS is used, the WTRU may know that the PDCCH is transmitted for itself. If a group common LP WUS is used, the WTRU may further determine whether the PDCCH is transmitted for itself or for other WTRUs in the WTRU group. The WTRU may then go to 6a.

At 5b (e.g., if the WTRU does not detect the LP WUS), the WTRU may expect no PDCCH in the following DRX on duration that may indicate (e.g., schedule) a transmission. As a result, the WTRU may not wake up its main receiver chain (e.g., the WTRU may keep the main receiver sleeping), and may go to 6b.

At 6a, the WTRU may decode (e.g., blindly decode) the DCI carried on the PDCCH, for example, in a PDCCH monitoring occasion during the DRX on duration. If the WTRU successfully decodes the DCI, the WTRU may further receive a transmission scheduled by the DCI and trigger the inactivity timer described herein. When the inactivity timer expires, the WTRU may turn off its main receiver and enter a sleep mode until the next DRX on duration. If the WTRU does not decode any DCI at 6a (e.g., due an error condition), the WTRU may turn off its main receiver and enter the sleep mode immediately after the PDCCH monitoring occasion, or the WTRU may enter the sleep mode based on the expiration of a timer (e.g., the same inactivity timer or a different timer). The WTRU may keep sleeping (e.g., with the main receiver turned off) until the next DRX on duration. The WTRU may then return to 3 to monitor for an LP WUS for the next DRX on duration and determine whether to wake up its main receiver chain based on whether the LP WUS is received.

At 6b, the WTRU may keep sleeping (e.g., with the main receiver turned off) until the next DRX on duration. The WTRU may then return to 3 to monitor for an LP WUS for the next DRX on duration and determine whether to wake up its main receiver chain based on whether the LP WUS is received.

In examples, the WTRU may determine whether to wake up its main receiver chain based on information carried by an LP WUS. For example, the LP WUS may carry 1-bit information (e.g., a flag bit) indicating whether the WTRU should wake up its main receiver chain. The indication may be provided explicitly (e.g., as part of the payload of the LP WUS) or implicitly. For example, a network (e.g., a base station) may be capable of transmitting multiple (e.g., two) candidate LP WUSes. Depending on which LP WUS is transmitted by the network, the WTRU may determine whether to wake its main receiver chain.

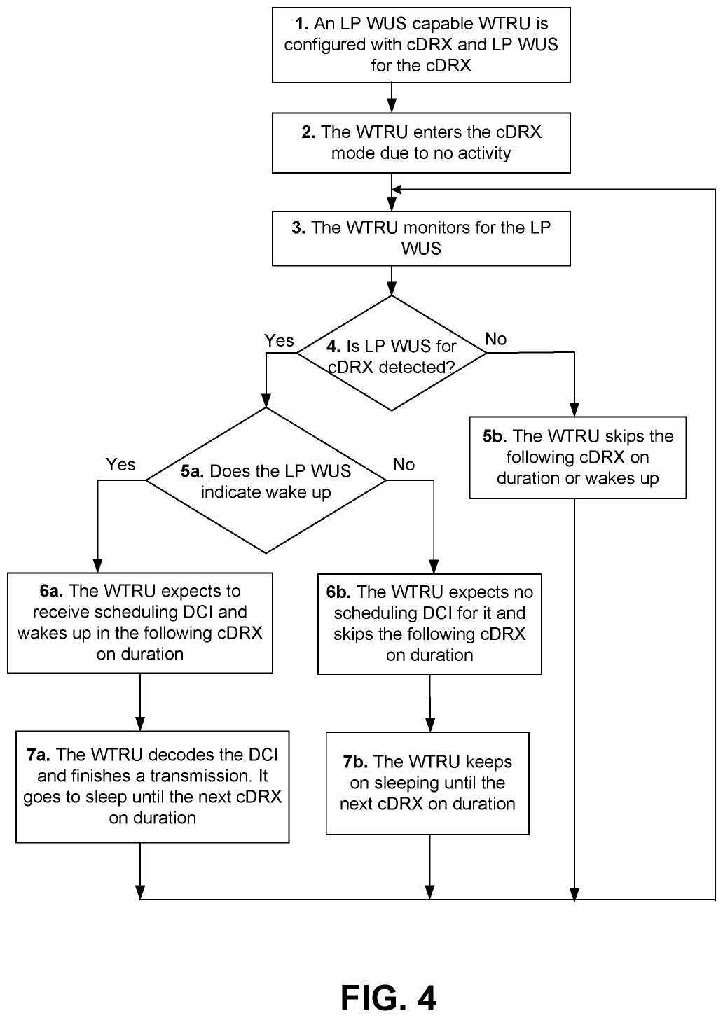

FIG. 4 illustrates an example of a wake-up procedure. At 1, an LP capable WTRU operating in an RRC connected state may enter a cDRX mode. The WTRU may be configured with (e.g., receive configuration information for) the cDRX mode and/or an LP WUS associated with the cDRX mode. At 2, the WTRU may trigger an inactivity timer if there is no transmission or reception (e.g., if there is no PDCCH scheduling a transmission). The inactivity timer may be restarted if the WTRU subsequently receives a PDCCH scheduling a transmission. Upon the expiration of the inactivity timer, the WTRU may enter the cDRX mode.

At 3, the WTRU may keep its main receiver chain sleeping (e.g., deactivated) while using an LP receiver to monitor for an LP WUS (e.g., to save power). The WTRU may keep the LP receiver on (e.g., always on) while the WTRU is in the cDRX mode, or the WTRU may turn on the LP receiver based on an indication to detect an LP WUS (e.g., based on a configured time/frequency location for receiving the LP WUS). The WTRU may detect the LP WUS at a configured resource location, or blindly detect the LP WUS within a configured resource range or region.

At 4, the WTRU may determine whether it has detected an LP WUS (e.g., before a cDRX on duration). If the WTRU determines that it has detected the LP WUS, the WTRU may go to 5a. If the WTRU determines that it has not detected the LP WUS, the WTRU may go to 5b.

At 5a, the WTRU may check the information carried by the LP WUS. If the information carried by the LP WUS indicates that the WTRU is to wake up its main receiver chain, the WTRU may proceed to 6a. If the information carried by the LP WUS indicates not to wake up the main receiver chain, the WTRU may procedure 6b. At 5b, if the WTRU does not detect the LP WUS (e.g., the WTRU may have missed the LP WUS due to bad channel conditions, blockage issues, or coverage issues), the WTRU may wake up its main receiver chain to blindly decode information in the following DRX on duration (e.g., to ensure no potential DCI is missed), or the WTRU may skip the following DRX on duration and assume no DCI is targeted for it. The WTRU may then wait for the next DRX on duration to save power. These behaviors of the WTRU may apply at least to the case where latency is low (e.g., if the WTRU is a machine-type communication (MTC) device).

The WTRU's behavior at 5b may be configured by a network, for example, through RRC signaling or a MAC CE. For example, the WTRU may be configured to skip the next DRX on duration (e.g., not to wake up its main receiver, not to monitor for a PDCCH transmission, etc.) if the WTRU does not detect the LP WUS. The WTRU may also be configured to perform one or more of the following actions in any combination or order. For example, the WTRU may be configured to monitor a PDCCH during the next DRX cycle (e.g., the next DRX on duration) if the WTRU does not detect the LP WUS. The WTRU may be configured to wake up its main receiver chain ahead of the next DRX cycle or in the next DRX cycle (e.g., in the next DRX on duration) if the WTRU does not detect the LP WUS. The WTRU may determine whether to skip PDCCH monitoring or to monitor for a PDCCH transmission (e.g., including waking up its main receiver chain) during the next DRX cycle based on configuration information received from the network (e.g., by a gNB). The configuration information may indicate conditions associated with the PDCCH monitoring including, for example, an RSRP threshold, a distance threshold, in/out of coverage, etc. An LP WUS received by the WTRU may trigger a procedure for connection re-establishment, for example, through beam recovery, link recovery, etc. The connection re-establishment may be triggered by a missed LP WUS or may be triggered by k consecutively missed LP WUSes, where k may be configured by the network (e.g., through RRC configuration). The WTRU may return to 3 after 5b to monitor for another LP WUS and determine whether to wake up its main receiver chain based on whether the LP WUS is detected.

At 6a (e.g., if the LP WUS indicates that the WTRU should wake up its main receiver chain), the WTRU may expect a PDCCH transmission (e.g., scheduling a transmission) in the following DRX on duration. The WTRU may wake up its main receiver chain to receive the PDCCH transmission. If a WTRU-specific LP WUS is used, the WTRU may know that the PDCCH is transmitted for the WTRU. If a group common LP WUS is used, the WTRU may further determine whether the PDCCH is transmitted for the WTRU or for other WTRUs in the WTRU group. The WTRU may then go to 7a.

At 6b (e.g., if the LP WUS indicates that the WTRU should not wake up its main receiver chain), the WTRU may expect no PDCCH transmission (e.g., no scheduling DCI) in the following DRX on duration. As a result, the WTRU may not wake up its main receiver chain (e.g., the WTRU may keep sleeping). The WTRU may then go to 7b.

At 7a, the WTRU may decode (e.g., blindly decode) DCI in a PDCCH monitoring occasion during the DRX on duration. If the WTRU successfully decodes the DCI, the WTRU may receive a scheduled transmission and may trigger the inactivity timer described herein. When the inactivity timer expires, the WTRU may deactivate (e.g., turn off) its main receiver and go to sleep mode until the next DRX on duration. If the WTRU decodes no DCI at 7a, the WTRU may turn off the main receiver and go to sleep after (e.g., immediately after) the PDCCH monitoring occasion. The WTRU may also be configured to go to sleep after a timer expires (e.g., the WTRU may reuse the inactivity timer or be configured with a different timer for this purpose). The WTRU may keep sleeping (e.g., with its main receiver turned off) until the next DRX on duration. The WTRU may then return to 3 to monitor for another LP WUS and determine whether to wake up its main receiver chain based on whether the LP WUS is detected.

At 7b, the WTRU may keep sleeping (e.g., with its main receiver turned off) until the next DRX on duration. The WTRU may then return to 3 to monitor for another LP WUS and determine whether to wake up its main receiver chain based on whether the LP WUS is detected.

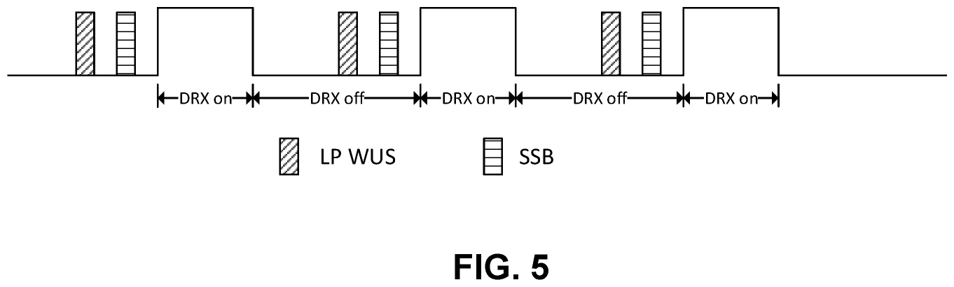

The WTRU may use the LP receiver described herein to determine whether there is data transmission for the WTRU. While doing that, the WTRU may turn off its main radio to save power. If the main radio is turned off for too long, the WTRU may risk losing synchronization with the network. A synchronization/physical broadcast channel (PBCH) block (SSB) may be transmitted between the LP WUS and a DRX on duration to help the WTRU maintain synchronization, as illustrated by FIG. 5. In the example shown in FIG. 5, the WTRU may wake up its main receiver in response to detecting an LP WUS using the LP receiver. The WTRU may use the main receiver to search for a transmitted SSB and to refine or re-establish its synchronization based on the SSB. The WTRU may decode a DCI in a DRX on duration. The WTRU may perform a wake-up procedure such as that illustrated by FIG. 3 or FIG. 4. The WTRU may wake up its main receiver to re-synchronize periodically after sleeping for a certain time period (e.g., for a number of time units or symbols, which may be configured via RRC signaling). In examples, an SSB (e.g., only the SSB) that the WTRU was using before entering the cDRX mode may be transmitted, and the WTRU may search (e.g., only search) for this SSB to obtain synchronization before a DRX on duration. These examples may apply to the scenario where the WTRU is operating in a specific frequency range or band such as frequency range 1 (FR1) or the 4.1 GHz to 7.125 GHz frequency band. In examples, the LP WUS may carry assistance information for the WTRU to know which SSB may be used for synchronization.

In examples, if the WTRU is configured to use fine beams to receive transmissions (e.g., if the WTRU is operating in FR2_1 such as 24.25 GHz to 52.6 GHz, or in FR2_2 such as above 52.6 GHz), an SSB burst may be transmitted. The SSB burst may carry multiple SSB transmissions for SSB sweeping. An SSB (e.g., each SSB) may be associated with a beam pointing in a certain direction. The SSB sweeping may be a full sweeping or may be a partial sweeping. For example, depending on the mobility of the WTRU, the network (e.g., a gNB) may decide how many beams are to be swept. An original beam and one or more adjacent beams may be used for partial beam sweeping. The SSBs associated with these beams may be transmitted by the gNB. The WTRU may search for these SSBs before a DRX on duration. Based on the searching result, the WTRU may obtain synchronization and/or perform beam refinement to receive a subsequent transmission. The WTRU may derive the SSB used by the main receiver from the direction of the WUS received by the WTRU.

In examples, an LP WUS may be transmitted before a regular SSB sweeping, for example, to avoid additional SSB transmission overhead. The LP WUS may carry assistance information for the WTRU to determine the cDRX on duration that the LP WUS may be associated with.

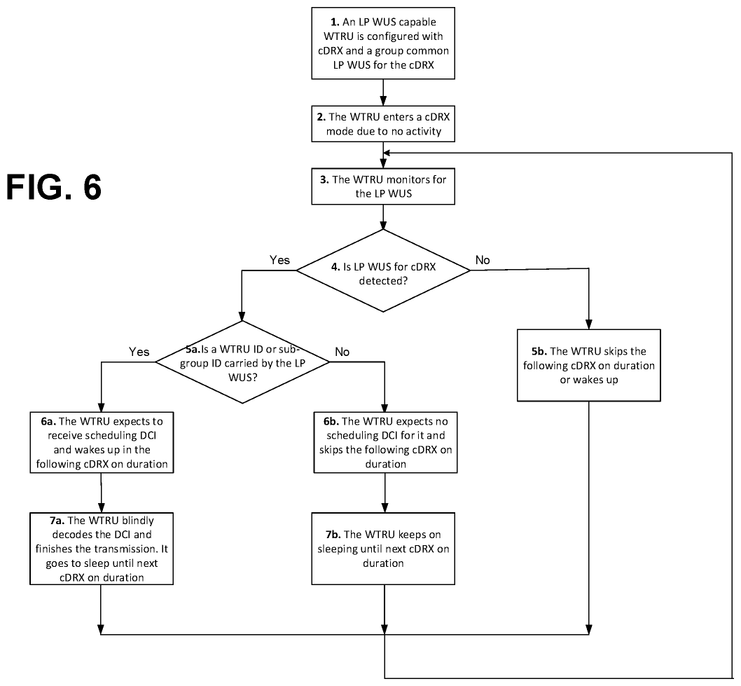

As described herein, an LP WUS may fulfill or serve a wake-up functionality. The LP WUS may also carry additional information to help a WTRU decode a PDCCH transmission. For example, when an LP WUS is transmitted in a group common manner, the LP WUS may include information indicating which specific WTRU or a sub-group of WTRUs within the WTRU group may wake up their respective main receiver chains. A (e.g., each) WTRU or sub-group of WTRUs may have a respective ID (e.g., a WTRU ID or sub-group ID) within the WTRU group, and the LP WUS may carry the WTRU ID or sub-group ID as a part of the payload explicitly or indicate the WTRU ID or sub-group ID implicitly. For example, an association may be established between an LP WUS sequence (e.g., including the time locations where LP wake-up signals may be transmitted) and the WTRU ID or sub-group ID (e.g., sequence 1 may be associated with ID 1, sequence 2 may be associated with ID 2, etc.). Depending on which LP WUS sequence is transmitted, the corresponding WTRU ID or sub-group ID may be implicitly indicated. If the LP WUS carries or implicitly indicates a WTRU ID or a sub-group ID, the corresponding WTRU(s) may wake up their main receivers in the following DRX on duration in response to receiving the LP WUS. If the LP WUS does not carry or indicate a WTRU ID or a sub-group ID, the corresponding WTRU(s) may skip the following DRX on duration and keep their main receivers sleeping until the next DRX cycle. FIG. 6 illustrates an example of such a procedure, which may include one or more of the following.

Operations 1-4 of FIG. 6 may be the same as operations 1-4 illustrated by FIG. 4, except that the LP WUS may be transmitted in a group common manner. At 5a of FIG. 6, the WTRU may check an ID carried by the LP WUS. If the LP WUS carries a WTRU ID or a sub-group ID associated with the WTRU, the WTRU may go to 6a. If the LP WUS does not carry a WTRU ID or a sub-group ID associated with the WTRU, the WTRU may go to 6b. Operations 5b-7b of FIG. 6 may be the same as 5b-7b of FIG. 4.

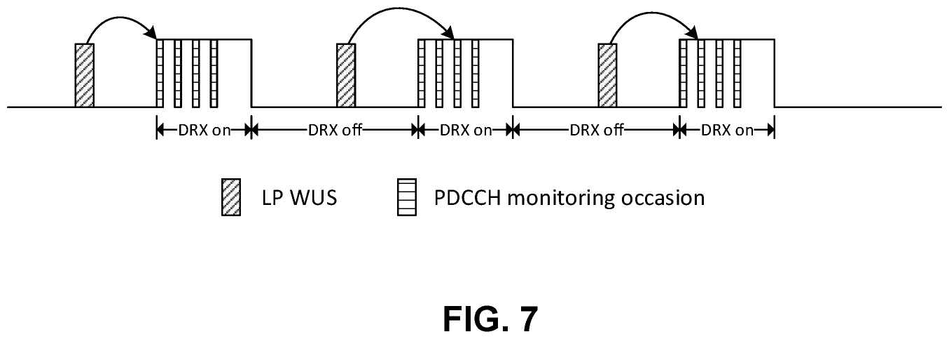

In examples, an LP WUS may carry assistance information to help a WTRU decode a PDCCH transmission. For example, the LP WUS may include information indicating which monitoring occasion may be used to detect DCI. FIG. 7 illustrates such an example. Assuming N PDCCH monitoring occasions may be configured within a DRX on duration, ceiling(log₂^{N}) bits may be carried by the LP WUS to indicate which PDCCH monitoring occasion DCI may be transmitted in. With this technique, the WTRU may not wake up its main receiver chain at the starting of a DRX on duration. Instead, the WTRU may keep the main receiver sleeping until the indicated PDCCH monitoring occasion. The WTRU may determine when to wake up its main receiver chain based on its capabilities. For example, the WTRU may decide to keep the main receiver sleeping for a longer time to achieve additional power saving.

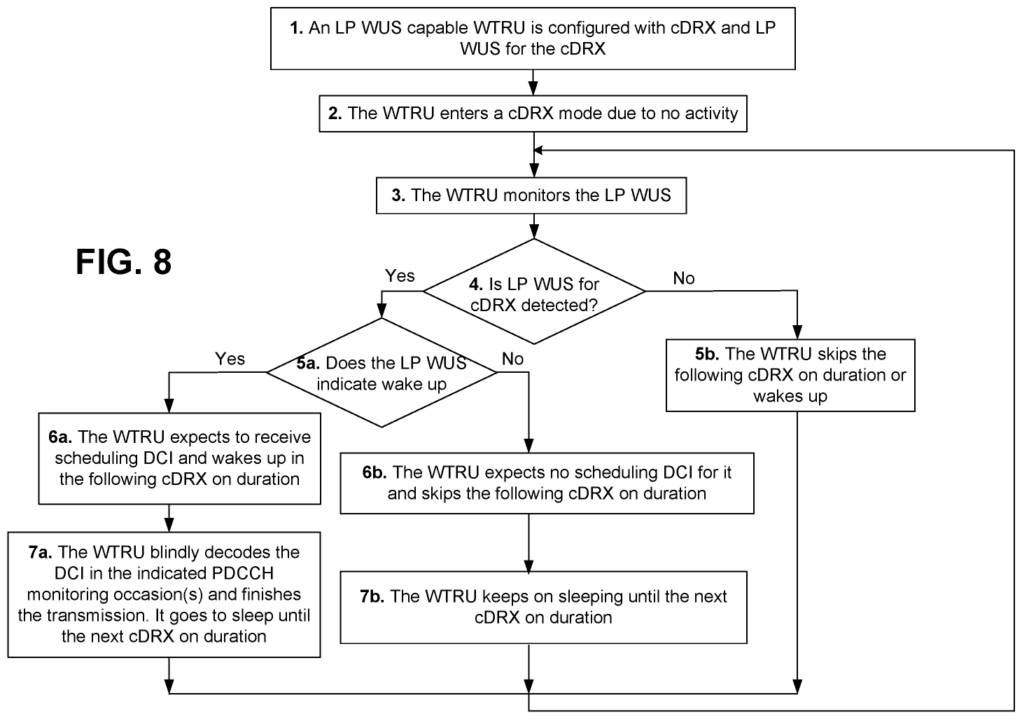

An LP WUS may indicate a range of PDCCH monitoring occasions (e.g., instead of indicating one PDCCH monitoring occasion). For example, the LP WUS may indicate k out of N PDCCH monitoring occasions to be monitored, where k<N or k≤N. The LP WUS may indicate a bitmap associated with the PDCCH monitoring occasions. For example, the LP WUS may indicate an N-bit bitmap, in which a bit (e.g., each bit) may be associated with a respective PDCCH monitoring occasion. When a bit is set to ‘1’, the WTRU may monitor the associated PDCCH monitoring occasion. When a bit is set to ‘0’, the WTRU may skip the associated PDCCH monitoring occasion. The LP WUS may indicate the PDCCH monitoring occasion information separately from a wake-up indication. For example, 1 bit in the LP WUS may be used for the wake-up indication and ceiling(log₂^{N}) bits in the LP WUS may be used to indicate the PDCCH monitoring occasion indices. In examples, these two pieces of information may be jointly indicated. For example, ceiling(log₂^{N+1}) bits may be used to carry information from (ceiling(log₂^{N+1}))² possible codepoints, where one codepoint may be used to indicate that no transmission is scheduled and that the WTRU may not wake up its main receiver chain, and the other codepoints may be used to indicate the PDCCH monitoring occasion indices. FIG. 8 illustrates an example procedure that utilizes the technique described herein, which may include one or more of the following operations.

Operations 1-6b of FIG. 8 may be the same as operations 1-6b of FIG. 4. Further, at 7a of FIG. 8, a WTRU may check the PDCCH monitoring occasion(s) indicated by an LP WUS. The WTRU may wake up its main receiver before an indicated monitoring occasion (e.g., based on the WTRU's capabilities). The WTRU may decode (e.g., blindly decode) the DCI in the indicated monitoring occasion and may ignore other monitoring occasions within a DRX on duration. If the WTRU decodes the DCI, the WTRU may receive a scheduled transmission and trigger the inactivity timer described herein. Once the inactivity timer expires, the WTRU may turn off its main receiver and enter a sleep mode until the next DRX on duration. If there is no DCI decoded, the WTRU may turn off its main receiver and enter the sleep mode after (e.g., immediately after) the PDCCH monitoring occasion, or the WTRU may be configured to enter the sleep mode based on the expiration of a timer (e.g., the WTRU may reuse the inactivity timer or use a different timer for this purpose). The WTRU may keep sleeping (e.g., with the main receiver turned off) until the next DRX on duration. The WTRU may then return to 3 to monitor for another LP WUS and determine whether to wake up its main receiver chain based on whether the LP WUS is detected. 7b of FIG. 7 may be same as 7b of FIG. 4.

As described herein, an LP WUS may carry one or more pieces of additional information, such as, e.g., a WTRU ID, a sub-group ID, and/or a PDCCH monitoring occasion indication. In addition to or in lieu of these information (e.g., which may help the WTRU decode a PDCCH), the LP WUS may carry partial scheduling information or complete scheduling information. If the LP WUS carries partial scheduling information, a WTRU may decode a PDCCH to obtain the remaining part of the scheduling information. If the LP WUS carries complete scheduling information, the WTRU may directly receive the scheduled transmission (e.g., without decoding a PDCCH).

If a WTRU-specific LP WUS is used, and the corresponding WTRU detects the LP WUS and wakes up its main receiver chain to decode a PDCCH, but detects no DCI, the WTRU may determine that an error may have occurred. In this case, the WTRU may send a report to the network (e.g., to a base station) to indicate the error and ask the network to retransmit the DCI.

An LP capable WTRU may be configured to use an LP WUS or a legacy WUS (e.g., which may consume more power than the LP WUS) during a cDRX mode. The WTRU may be equipped with an LP receiver that may not have the same coverage as a main receiver (e.g., due to receiver sensitivity). For some WTRUs (e.g., cell edge WTRUs), relying (e.g., only relying) on an LP WUS during the cDRX mode may impact system performance. More small cells supporting LP signal transmissions may be deployed to alleviate the impact, but deployment and/or maintenance costs may increase.

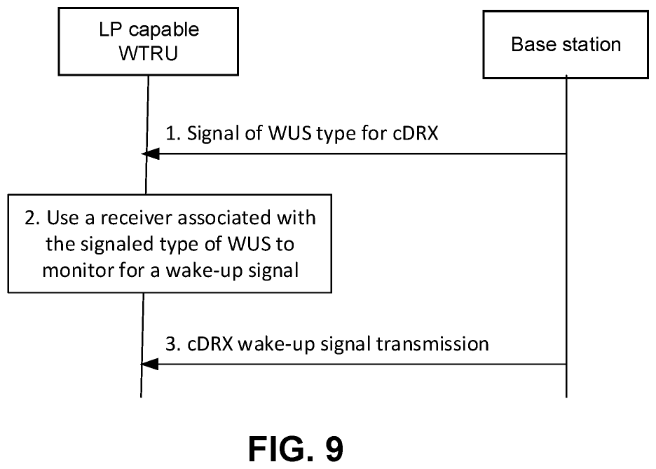

An LP capable WTRU may be configured to use both an LP WUS and a legacy WUS during a cDRX mode (e.g., to solve the issue described above). The WTRU may use the LP WUS in some scenarios and may use the legacy WUS in other scenarios (e.g., the WTRU may monitor for one type of wake-up signals at a time). The WTRU may determine when to use an LP receiver and when to use a main receiver to monitor for a wake-up signal. In examples, the network (e.g., a base station) may determine and indicate which type of wake-up signals may be used for a cDRX mode. The network may make the determination with or without help from the WTRU (e.g., the decision may be solely by the network). FIG. 9 illustrates an example call flow associated with this technique, which may include one or more of the following. At 1, a network (e.g., a base statin) may decide which type of wake-up signals (e.g., an LP WUS or a legacy WUS) may be used by a WTRU (e.g., during a cDRX mode). The network may signal/indicate the decision to the WTRU via RRC signaling or via an MAC CE. At 2, the WTRU may monitor for the type of wake-up signals decided/indicated by the network using a corresponding receiver (e.g., before a cDRX on duration). For the WUS type(s) not indicated in 1, the WTRU may not monitor for them (e.g., during the cDRX mode). At 3, the network may transmit the type of wake-up signals decided/indicated in 1 (e.g., before a cDRX on duration) and may perform one or more subsequent procedures associated with the cDRX. For example, if the network has data for the WTRU, the network may use the WUS to wake up the WTRU and may send DCI and/or a PDSCH transmission to the WTRU. If the network has no data for the WTRU, the network may send a WUS to the WTRU to indicate that the WTRU should not wake up, or the network may not send any WUS to WTRU.

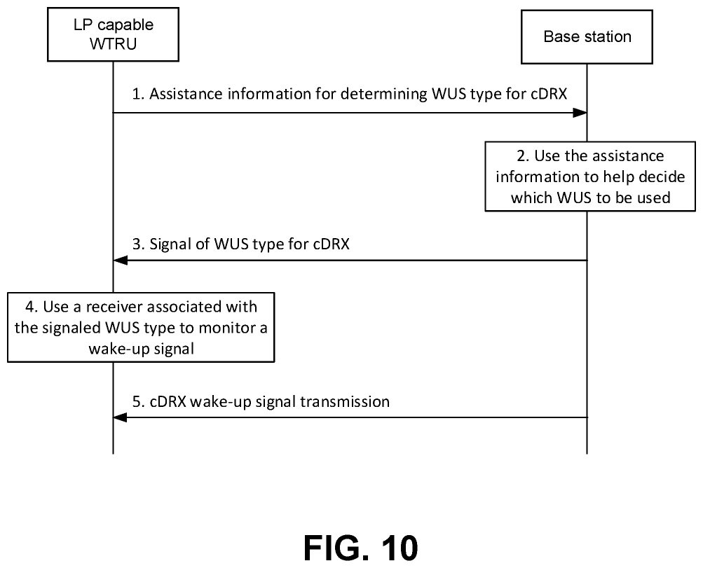

In examples, the network may make the decision regarding which wake-up signal to use with help from the WTRU (e.g., the WTRU may send assistance information to the network to help with the decision making). FIG. 10 illustrates an example of a call flow associated with this technique, which may include one or more of the following. At 1, a WTRU may provide assistance information to the network (e.g., a base station) to help the network decide which type of WUS may be used. The assistance information may include one or more of the following parameters: a reference signal received power (RSRP), the WTRU's position, the WTRU's velocity, the WTRU's moving direction, the WTRU's distance to the network, a suggested WUS (e.g., a legacy WUS or LP WUS) to be used, the WTRU's capabilities for an LP WUS, the WTRU's battery status, etc. At 2, the network may use the assistance information provided by the WTRU to decide which type(s) of wake up signals may be used for (e.g., for a cDRX cycle). Operations 3-5 of FIG. 10 may be the same as operations 1-3 of FIG. 9.

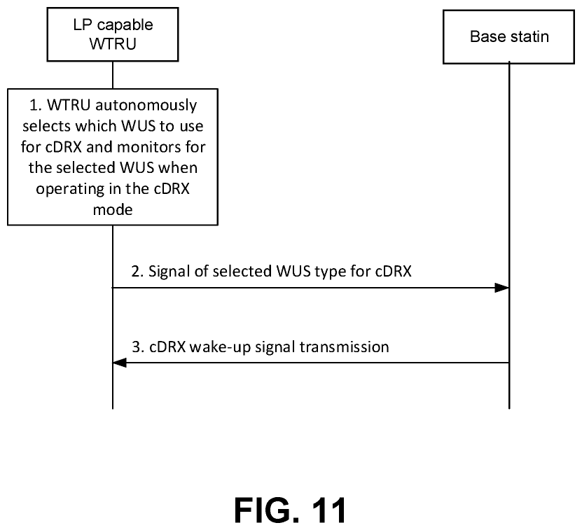

In the examples illustrated by FIG. 9 and FIG. 10, the decision may be made by the network. In other examples, a WTRU may make the decision regarding which WUS to use for a cDRX mode. The WTRU may send the decision to the network and the network may transmit the WUS decided/selected by the WTRU. The WTRU may send the decision to the network using fewer bits than those used to transmit assistance information (e.g., 1 bit may be used to indicate whether an LP WUS or a legacy WUS is selected), which may reduce signaling overhead. FIG. 11 shows an example of a call flow associated with selecting a WUS at the WTRU side (e.g., autonomously by the WTRU). At 1, a WTRU may autonomously determine which WUS (e.g., an LP WUS or a legacy WUS) may be used when the WTRU is operating in a cDRX mode, and the WTRU may monitor for the WUS to determine whether to wake up its main receiver chain. At 2, the WTRU may indicate the selected WUS to the gNB. This indication may be transmitted through UCI or through higher layer reporting. At 3, the network may transmit the type of WUS indicated by the WTRU in 2 (e.g., before a cDRX on duration) and may perform one or more subsequent operations associated with the cDRX, as described herein.

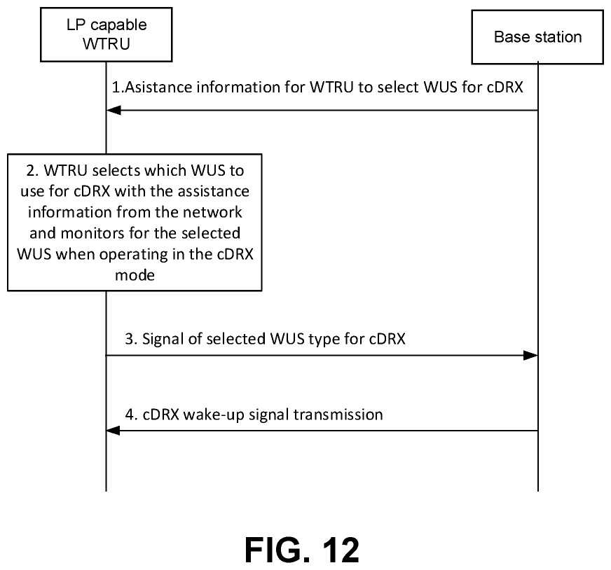

In examples, the network may help the WTRU make a decision regarding which wake-up signal to use. For example, the network may configure criteria (e.g., one or more threshold values) that may be used by the WTRU to make the decision. FIG. 12 illustrates an example of a call flow associated with this technique. At 1, the network may transmit assistance information to the WTRU for selecting a WUS (e.g., for a cDRX mode). The network may transmit this information through RRC signaling or through an MAC CE. The information transmitted by the network may indicate criteria that may be used by the WTRU for selecting the WUS. The criteria may include one or more of the following: an RSRP, a distance between the WTRU to the network, the size of the WUS, latency requirements, etc. For example, the network may indicate one or more threshold values associated with WUS selection (e.g., associated with the foregoing criteria) to the WTRU, and the WTRU may determine which WUS is suitable for a cDRX mode based on the threshold values.

At 2 of FIG. 12, a WTRU may select which WUS (e.g., an LP WUS or a legacy WUS) to use for a cDRX mode based on the assistance information provided by the network. For example, if an RSRP threshold value is configured/provided by the network, the WTRU may measure the RSRP and compare the measurement with the configured threshold. If the RSRP is greater than and/or equal to the threshold, the WTRU may choose to use an LP WUS for the cDRX. If the RSRP is smaller than and/or equal to the threshold, the WTRU may choose to use a legacy WUS. If the RSRP is too low, the WTRU may trigger a link re-establishment and/or beam recovery procedure. As another example, if a distance threshold value is configured by the network, the WTRU may compare its distance to the network with the threshold value. Such a distance may be determined based on the WTRU's position, the WTRU's velocity, the WTRU's moving direction, etc. The distance may be a current value, or a value predicted by the WTRU. If the distance is greater than and/or equal to the threshold value, the WTRU may choose to use a legacy WUS for the cDRX. If the distance is smaller than and/or equal to the threshold value, the WTRU may choose to use an LP WUS.

In examples, if a threshold value for a WTUS size is configured by the network, the WTRU may choose to use an LP WUS for cDRX if the size of the WUS is smaller than and/or equal the threshold value. If the size of the WUS is greater than and/or equal to the threshold, the WTRU may choose to use a legacy WUS for cDRX. In examples, if a threshold value associated with latency is configured by the network, the WTRU may choose to use an LP WUS for cDRX if the latency requirement of a service is smaller than and/or equal the threshold value. If the latency requirement of the service is greater than and/or equal to the threshold, the WTRU may choose to use a legacy WUS for cDRX. If multiple threshold values are configured by the network, the WTRU may make the decision based on a combination of those values.

At 3 of FIG. 12, the WTRU may indicate the selected WUS to the network. This indication may be transmitted, for example, through uplink control information (UCI) or through higher layer reporting. At 4, the network may transmit the type of WUS indicated by the WTRU (e.g., before a cDRX on duration) and may perform one or more subsequent procedures associated with the cDRX, as described herein.

In examples, the WTRU may miss an LP WUS transmitted by the network, for example, due to coverage issues, blockage, interference, etc. The WTRU may be configured to monitor for both an LP WUS and a legacy WUS to address this issue. For instance, the WTRU may, by default, monitor for the LP WUS during a cDRX mode using an LP receiver. The WTRU may then determine whether to wake up its main receiver chain based on information carried by the LP WUS. If no LP WUS is detected (e.g., in a DRX cycle), the WTRU may determine that an error may have occurred and the WTRU may turn on a main receiver to monitor for a legacy WUS as a fallback operation.

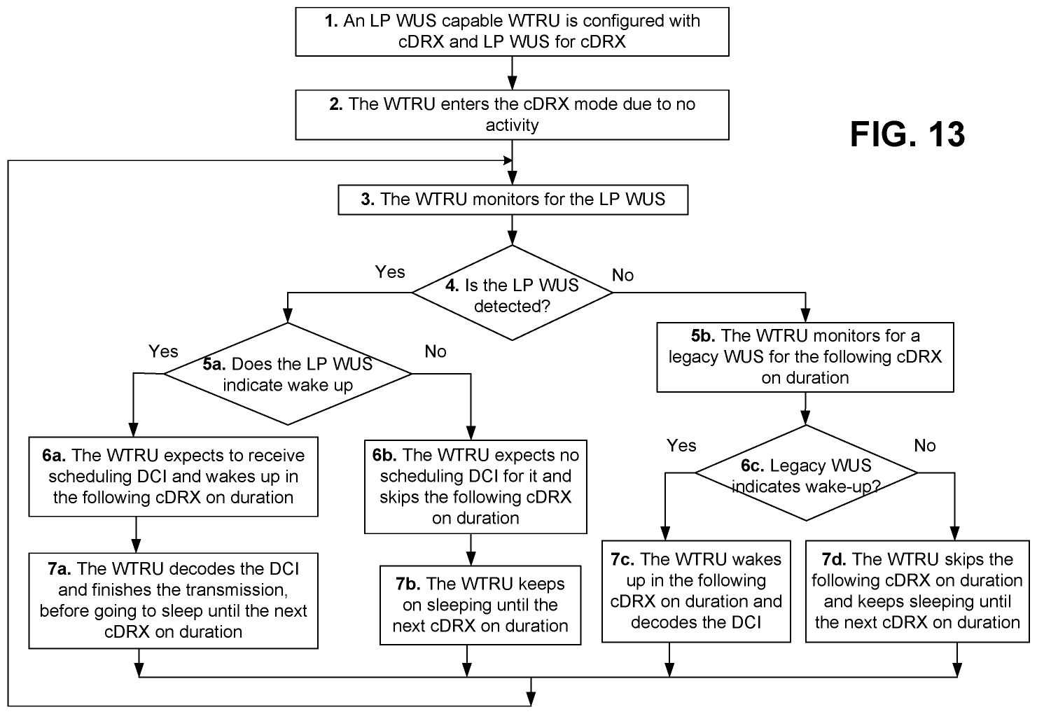

FIG. 13 illustrates an example of WUS monitoring, which may include one or more of the following operations. At 1, an LP capable WTRU operating in an RRC connected state may enter a cDRX mode. The WTRU may be provided with configuration information regarding the cDRX mode, an LP WUS associated with the cDRX, and/or a legacy WUS associated with the cDRX. The configuration information may indicate respective time offsets associated with the legacy WUS and the LP WUS (e.g., relative to the start of a cDRX on-duration). The configuration information may further indicate that the time offset associated with the legacy WUS is smaller than the time offset associated with the LP WUS. Based on this indication, the WTRU may check for the legacy WUS in case no LP WUS is received. The WTRU may use this technique to facilitate its operation in an unlicensed spectrum.

Operations 2-5a of FIG. 13 may be the same as operations 2-5a of FIG. 4. Further, at 5b of FIG. 13, if the WTRU does not detect an LP WUS, the WTRU may turn on its main receiver to monitor for a legacy WUS. The WTRU may then go to 6c. Operations 6a-6b of FIG. 13 may be the same as operations 6a-6b of FIG. 4. Further, at 6c of FIG. 13, the WTRU checks if it has received a legacy WUS. If the legacy WUS has been received and indicates that the WTRU should wake up, the WTRU may go to 7c. If the legacy WUS indicates that the WTRU should not wake up, the WTRU may go to 7d. If the WTRU does not detect the legacy WUS at 6c, the WTRU may handle the situation based on a configuration provided by the network. For example, the WTRU may be configured to skip the following cDRX on duration (e.g., turn off the main receiver during the following cDRX on duration) if the WTRU does not detect the legacy WUS, or the WTRU may be configured to monitor for another WUS in the following cDRX on duration if the WTRU does not detect the legacy WUS.

Operations 7a-7b of FIG. 13 may be the same as operations 6a-6b of FIG. 4. Further, at 7c of FIG. 13, the WTRU may attempt to decode (e.g., blindly decode) DCI in one or more PDCCH monitoring occasions during a DRX on duration. If the WTRU successfully decodes the DCI, the WTRU may receive a scheduled transmission based on the DCI and start an inactivity timer. Once the inactivity timer expires, the WTRU may turn off its main receiver and enter a sleep mode until the next DRX on duration. If the WTRU decodes no DCI at 7c, the WTRU may turn off its main receiver and enter the sleep mode after (e.g., immediately after) the PDCCH monitoring occasion, or the WTRU may be configured to enter the sleep mode based on the expiration of a timer (e.g., the WTRU may reuse the inactivity timer or a different timer for this purpose). The WTRU may stay in the sleep mode until the next DRX on duration. At 7d of FIG. 13, the WTRU may turn off the main receiver and enter the sleep mode (e.g., including a deep sleep mode) until the next DRX on duration. From 7a, 7b, 7c, and 7d, the WTRU may return to 3 to monitor for another LP WUS or legacy WUS, and determine whether to wake up its main receiver chain based on whether the LP WUS or legacy WUS is detected.

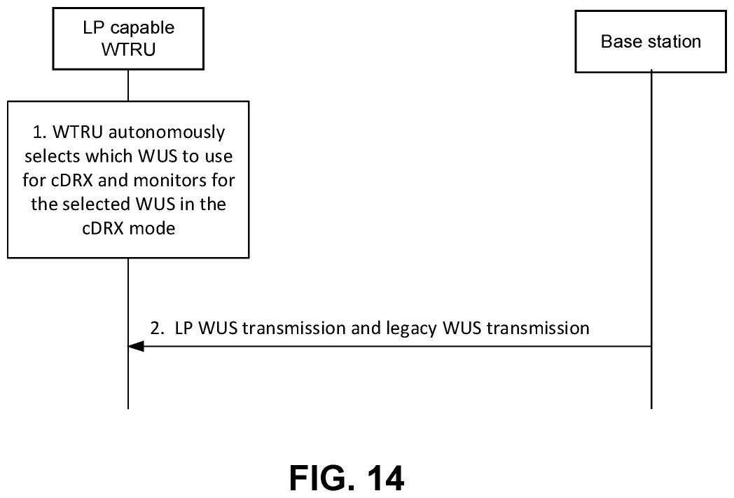

In the example shown in FIG. 13, the WTRU may monitor for the LP WUS first (e.g., as a default option) and the legacy WUS second (e.g., as a backup option if the WTRU does not detect the LP WUS). In other examples, the network may transmit both the LP WUS and the legacy WUS, and the WTRU may determine which one to monitor based on certain criteria. For instance, the WTRU may select which WUS to monitor for autonomously (e.g., without an indication from the network). FIG. 14 illustrates an example of WUS monitoring, which may include one or more of the following operations. At 1, the WTRU may autonomously determine/select which WUS (e.g., an LP WUS or a legacy WUS) to use for a cDRX mode, and the WTRU may monitor for the selected WUS (e.g., while in the cDRX mode) to determine whether to wake up its main receiver chain. At 2, the network may transmit an LP WUS and/or a legacy WUS (e.g., before a cDRX on duration), and the network may perform one or more subsequent procedures associated with the cDRX.

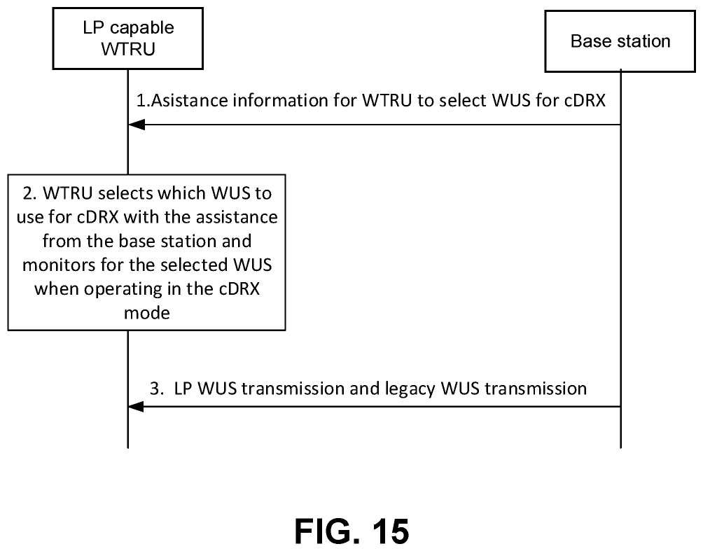

In examples, the WTRU may receive assistance information from the network regarding WUS selection and may make a selection decision based on the assistance information provided by the network. For example, the network may configure the WTRU with criteria (e.g., one or multiple threshold values) that may be used by the WTRU to select a WUS to monitor for. FIG. 15 illustrates an example call flow associated with the provisioning of assistance information. 1-2 of FIG. 15 may be the same as 1-2 illustrated by FIG. 12. Further, at 3 of FIG. 15, the network may transmit an LP WUS and/or a legacy WUS (e.g., before a cDRX on duration) for the WTRU to detect. The network may then perform one or more subsequent procedures associated with the cDRX.

An LP capable WTRU may use an LP WUS and a legacy WUS jointly during a DRX mode (e.g., such as a cDRX mode). In examples, the legacy WUS may be transmitted in a group common manner, and multiple WTRUs may monitor the same group common PDCCH to detect the WUS and determine whether to wake up based on the WUS. This may avoid the transmission of many WTRU-specific wake-up signals, thus reducing signaling overhead. Since the WUS may be a group common signal, it may wake up a group of WTRUs instead of a particular WTRU. As a result, a WTRU in the group may wake up in response to the WUS even though there may not be a transmission (e.g., a PDCCH transmission) for the WTRU to receive, causing the WTRU to waste power. If the WTRU group configured to receive the group common WUS is too large, power efficiency for the WTRU group may degrade. If the WTRU group configured to receive the group common WUS is too small, more transmissions of the group common WUS may need to be performed and the advantage of the group common WUS (e.g., lower signaling overhead compared to a WTRU-specific WUS) may be reduced or completely lost.

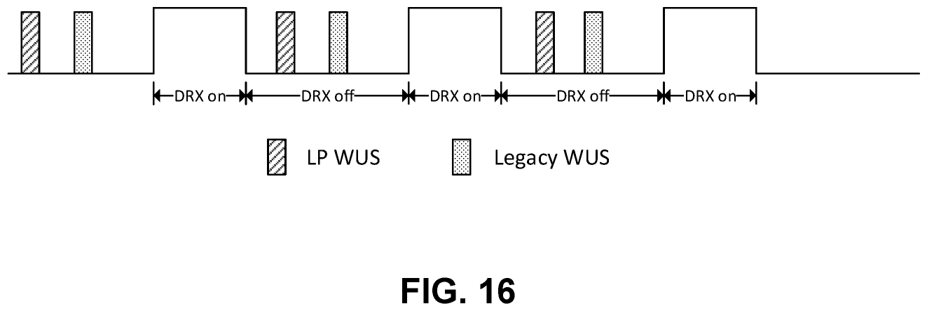

A joint (e.g., multi-stage) wake up technique using both a legacy WUS and an LP WUS may be used to address the issue described above (e.g., to achieve a balance between group common signaling and WTRU-specific signaling). FIG. 16 illustrates an example of a 2-stage wake-up procedure in which both an LP WUS and a legacy WUS may be transmitted in a group common manner. WTRUs may be divided into multiple groups (e.g., with relatively large group sizes), where each group may be associated with an LP WUS and the WTRUs within the group may be configured to monitor for the associated LP WUS to determine whether to further monitor for a legacy WUS (e.g., by waking up respective main receivers of the WTRUs).

The WTRUs of the group described above may be further divided into smaller groups (e.g., sub-groups), where each sub-group may be associated with a legacy WUS and the WTRUs in the sub-group may further determine whether to decode (e.g., blindly decode) DCI in a DRX on duration based on the legacy WUS. Using this technique, a balance may be maintained between the among of signaling and the number of WTRU wakeups by adjusting the respective sizes of the groups and sub-groups.

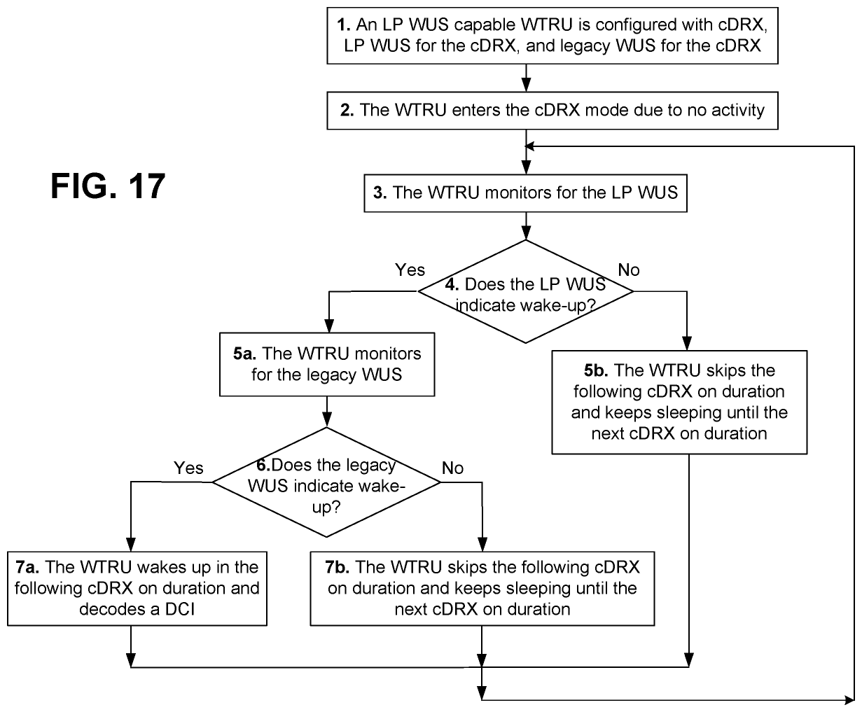

FIG. 17 illustrates an example of a multi-stage wake-up procedure, which may include one or more of the following operations. At 1, an LP capable WTRU operating in an RRC connected state may enter a cDRX mode. The WTRU may be provided with configuration information regarding the cDRX mode, an LP WUS associated with the cDRX mode, and a legacy WUS associated with the cDRX mode. Operation 2-3 of FIG. 17 may be the same as operations 2-3 illustrated by FIG. 4. Further, at 4 of FIG. 17, the WTRU may determine whether it has received an LP WUS indicating that the WTRU should further monitor for the legacy WUS (e.g., by waking up a main receiver chain of the WTRU). If the LP WUS indicates to monitor for the legacy WUS (e.g., by waking up the main receiver chain), the WTRU may go to 5a. If the LP WUS indicates not to monitor for the legacy WUS (e.g., not to wake up the main receiver chain), the WTRU may go to 5b.

The WTRU may determine whether to monitor for the legacy WUS (e.g., by waking up the main receiver chain) based on information carried by the LP WUS. If no LP WUS is detected at 4, the WTRU may determine that an error has occurred. For example, the WTRU may fail to detect the LP WUS due to bad channel conditions, blockage issues, or coverage issues. In those cases, the WTRU may wake up its main receiver chain to monitor for the legacy WUS, or the WTRU may skip the legacy WUS monitoring and/or the following DRX on duration, and assume that no DCI is targeted for the WTRU. The WTRU may then sleep until the next DRX cycle to save power (e.g., such behaviors may apply to cases where latency requirements are low such as for machine-type communication). The WTRU may be configured with behaviors for the above-mentioned scenario (e.g., the configuration may be received via RRC signaling or via an MAC CE). For example, the WTRU may be configured to skip legacy WUS monitoring and the following DRX on duration if the WTRU does not detect the LP WUS at 4, or the WTRU may be configured to wake up its main receiver chain to monitor for the legacy WUS if the WTRU does not detect the LP WUS at 4. The WTRU may determine whether to skip the legacy WUS monitoring or wake up its main receiver chain to monitor for the legacy WUS based on conditions configured by the network, which may include, e.g., an RSRP threshold, a distance threshold, an in/out of coverage condition, etc.

At 5a of FIG. 17, the WTRU may turn on its main receiver to monitor for the legacy WUS and further proceed to 6. At 5b of FIG. 17, the WTRU may skip the legacy WUS monitoring and/or the following DRX on duration (e.g., the WTRU may keep its main receiver sleeping until the next DRX on duration), and return to 3 to monitor for another LP WUS and/or legacy WUS.

At 6 of FIG. 17, the WTRU may determine whether it has received the legacy WUS indicating that the WTRU should receive a DCI (e.g., by waking up the WTRU's main receiver chain). If the legacy WUS has been received and indicates that the WTRU should receive the DCI, the WTRU may go to 7a. If the legacy WUS indicates that the WTRU should not receive the DCI, the WTRU may go to 7b. If no legacy WUS is detected, the operation in 4 may be applied (e.g., the WTRU may decide to skip a DRX on duration, to wake up, or to behave as configured by the network).

At 7a, the WTRU may attempt to receive and decode (e.g., blindly decode) DCI in one or more PDCCH monitoring occasions during a DRX on duration. If the WTRU successfully receives and decodes the DCI, the WTRU may receive a scheduled transmission and start an inactivity timer. Once the inactivity timer expires, the WTRU may turn off its main receiver and enter a sleep mode until the next DRX on duration. If there is no DCI decoded at 7a, the WTRU may turn off its main receiver and enter the sleep mode after (e.g., immediately after) the PDCCH monitoring occasion, or the WTRU may enter the sleep mode based on the expiration of a timer (e.g., the WTRU may reuse the inactivity timer or a different timer for this purpose). The WTRU may then stay in the sleep model until the next DRX on duration. At 7b, the WTRU may turn off the main receiver and enter the sleep mode until the next DRX on duration. From 7a and 7b, the WTRU may return to 3 to monitor for another LP WUS and legacy WUS, and determine whether to wake up its main receiver chain based on the LP WUS and the legacy WUS (e.g., jointly).

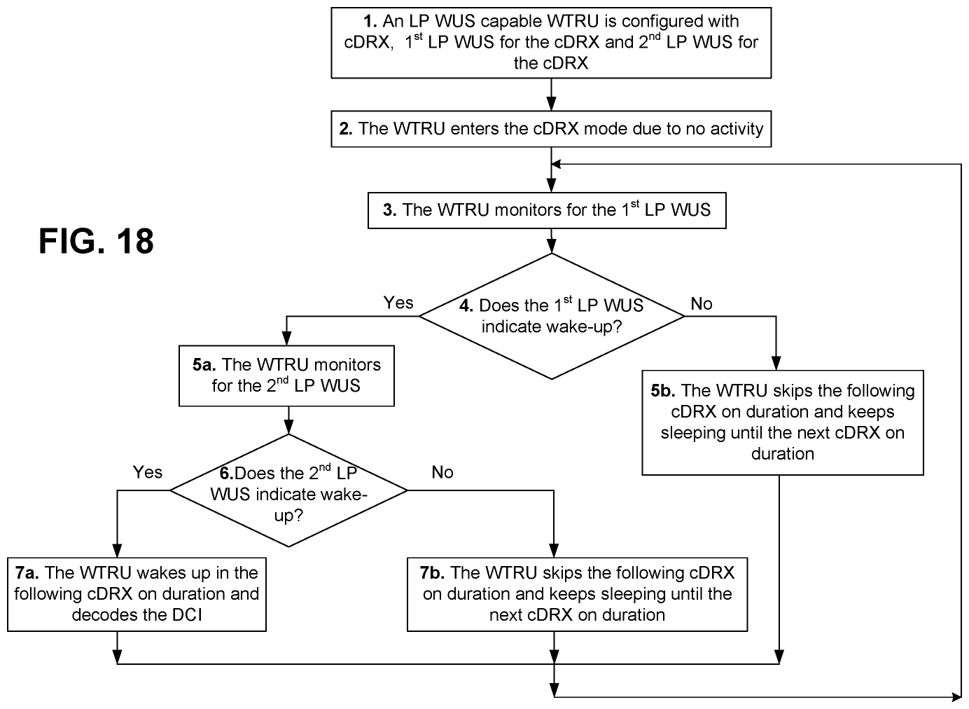

In the example shown in FIG. 17, the multi-stage (e.g., 2-stage) wake-up procedure may use the LP WUS and the legacy WUS during different stages of the procedure. In other examples, the multiple (e.g., two) stages of the procedure may all/both rely on the LP WUS. For example, a first group common LP WUS may be used for the first stage and a second group common LP WUS (or a WTRU-specific LP WUS) may be used for the second stage. FIG. 18 illustrates an example of such a procedure, which may include one or more of the following operations. At 1, an LP capable WTRU operating in an RRC connected state may enter a cDRX mode. The WTRU may be provided with configuration information regarding the cDRX mode, a first LP WUS (e.g., for a first stage of the wake-up procedure) for the cDRX, and a second LP WUS (e.g., for a second stage of the wake-up procedure) for the cDRX. Operation 2-3 of FIG. 18 may be the same as operations 2-3 illustrated by FIG. 4. Further, at 4 of FIG. 18, the WTRU may determine whether it has received the first LP WUS indicating that the WTRU should wake up. If the first LP has been received and indicates that the WTRU should wake up, the WTRU may go to 5a. If the first LP WUS indicates that the WTRU should not wake up, the WTRU may go to 5b.

The WTRU may determine whether to further monitor for the second LP WUS based on information carried by the first LP WUS. If no first LP WUS is detected at 4, the WTRU may determine that an error has occurred. For example, the WTRU may fail to detect the first LP WUS due to bad channel conditions, blockage issues, or coverage issues. When this happens, the WTRU may continue to monitor for the second LP WUS, or the WTRU may skip the second LP WUS monitoring and/or the following DRX on duration, and assume that no DCI is targeted for the WTRU. The WTRU may sleep until the next DRX cycle to save power (e.g., such behaviors may apply to cases when latency requirements are low such as for machine-type communication). The WTRU may be configured with behaviors for the above scenario (e.g., the configuration may be provided via RRC signaling or an MAC CE). For example, the WTRU may be configured to skip the second LP WUS monitoring and/or the following DRX on duration if the WTRU does not detect the first LP WUS at 4, or the WTRU may be configured to continue to monitor for the second LP WUS if the WTRU does not detect the first LP WUS at 4. The WTRU may determine whether to skip or continue to monitor for the 2nd LP WUS based on conditions or criteria configured by the network, which may include an RSRP threshold, a distance threshold, an in/out of coverage condition, etc.

At 5a of FIG. 18, the WTRU may continue to monitor for the second LP WUS and then proceed to 6. The second LP WUS may be transmitted in a group common manner or in a WTRU-specific manner. Before detecting the second LP WUS, the WTRU may keep its main receiver chain sleeping. At 5b, the WTRU may skip monitoring for the second LP WUS and/or skip the following DRX on duration (e.g., the WTRU may keep its main receiver sleeping until the next DRX on duration). The WTRU may then return to 3 to monitor for another transmission of the first LP WUS and/or the second LP WUS.

At 6 of FIG. 18, the WTRU may determine whether it has received the second LP WUS indicating that the WTRU should receive a DCI (e.g., by waking up the WTRU's main receiver chain). If the second LP WUS has been received and indicates that the WTRU should receive the DCI (e.g., by waking up the main receiver chain), the WTRU may go to 7a. If the second LP WUS indicates that the WTRU should not receive the DCI (e.g., by waking up the main receiver chain), the WTRU may go to 7b.

If the wake-up decision is based on information carried by the second LP WUS and the WTRU does not detect the second LP WUS, the WTRU may determine that an error has occurred and the WTRU may apply one or more of the operations described with respect to 4 (e.g., the WTRU may skip the next DRX on duration, wake up its main receiver chain, or behave according to configuration information provided by the network).

At 7a of FIG. 18, the WTRU may wake up its main receiver chain and attempt to receive and decode (e.g., blindly decode) DCI in the PDCCH monitoring occasions during a DRX on duration. If the WTRU successfully receives and decodes the DCI, the WTRU may receive a scheduled transmission and start an inactivity timer. Once the inactivity timer expires, the WTRU may turn off its main receiver and enter a sleep mode until the next DRX on duration. If there is no DCI decoded at 7a, the WTRU may turn off the main receiver and enter the sleep mode after (e.g., immediately after) the PDCCH monitoring occasion, or the WTRU may enter the sleep mode based on the expiration of a timer (e.g., the WTRU may reuse the inactivity timer or a different timer for this purpose). The WTRU may then stay in the sleep mode until the next DRX on duration.

If a WTRU-specific LP WUS is used for the second LP WUS, and there is no DCI decoded at 7a, the WTRU may determine that an error has occurred. In at situation, the WTRU may send a report to the network to indicate the error and may ask the network to retransmit the DCI (e.g., scheduling DCI). The WTRU may then return to 3 to monitor for another transmission of the first LP WUS and/or the second LP WUS to determine whether to wake up its main receiver chain.

At 7b, the WTRU may turn off the main receiver and enter the sleep mode until the next DRX on duration. The WTRU may return to 3 to monitor for another transmission of the first LP WUS and/or the second LP WUS, and determine whether to wake up its main receiver chain based on those signals (e.g., jointly).

The examples provided herein may describe the WTRU receiving an LP WUS from the network, but those skilled in the art will appreciate that the WTRU may receive the LP WUS from another WTRU (e.g., a relay WTRU) or other devices or nodes in the communication system. When receiving the LP WUS from other WTRUs or nodes, the mechanisms described in this disclosure may still apply. In examples, the WTRU may receive an LP WUS for another WTRU and act as a relay to forward the received LP WUS to a target WTRU. The examples provided herein may describe how an LP WUS may be applied to a cDRX mode (e.g., for a WTRU operating in an RRC connected state), but the examples may also apply to a WTRU operating in an RRC idle or inactive state. For example, the examples related to adopting an LP WUS for cDRX may also be used when the WTRU is operating in a DRX mode in an RRC idle/inactive state (e.g., by replacing the legacy WUS with a paging early indication (PEI).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
enter a discontinuous reception (DRX) mode;
monitor for a first signal while in the DRX mode; and
based on a determination that the first signal has been received and that the first signal indicates that the WTRU is to monitor for a second signal:
activate a receiver for receiving the second signal while in the DRX mode, wherein the second signal is associated with a power consumption that is higher than a power consumption associated with the first signal; and
based on a determination that the second signal has been received and that the second signal indicates that the WTRU is to monitor for downlink control information (DCI):
receive the DCI; and
decode the DCI.

2. (canceled)

3. (canceled)

4. The WTRU of claim 1, wherein the first signal is associated with a first WTRU group that includes the WTRU, wherein the second signal is associated with a second WTRU group that includes the WTRU, and wherein the first WTRU group includes more WTRUs than the second WTRU group.

5. The WTRU of claim 1, wherein the first signal is transmitted to a WTRU group comprising the WTRU, and wherein the second signal is transmitted specifically to the WTRU.

6. The WTRU of claim 1, wherein the processor is further configured to receive configuration information that indicates one or more time positions for the WTRU to monitor for the first signal.

7. The WTRU of claim 1, wherein, based on a determination that the first signal has not been received or that the first signal includes no indication for the WTRU to monitor for the second signal, the processor is further configured to sleep through a subsequent DRX on duration, and wherein, based on a determination that the second signal has not been received or that the second signal includes no indication for the WTRU to monitor for the DCI, the processor is further configured to sleep through a subsequent DRX on duration.

8. The WTRU of claim 1, wherein the processor is configured to enter the DRX mode while in a radio resource control (RRC) connected state.

9. A method implemented by a wireless transmit/receive unit (WTRU), the method comprising:
entering a discontinuous reception (DRX) mode;
monitoring for a first signal while in the DRX mode; and
based on a determination that the first signal has been received and that the first signal indicates that the WTRU is to monitor for a second signal:
activating a receiver for receiving the second signal while in the DRX mode, wherein the second signal is associated with a power consumption that is higher than a power consumption associated with the first signal; and
based on a determination that the second signal has been received and that the second signal indicates that the WTRU is to monitor for downlink control information (DCI):
receiving the DCI; and
decoding the DCI.

10. (canceled)

11. The method of claim 9, wherein the first signal is associated with a first WTRU group that includes the WTRU, wherein the second signal is associated with a second WTRU group that includes the WTRU, and wherein the first WTRU group includes more WTRUs than the second WTRU group.

12. The method of claim 9, wherein the first signal is transmitted to a WTRU group comprising the WTRU, and wherein the second signal is transmitted specifically to the WTRU.

13. The method of claim 9, further comprising receiving configuration information that indicates one or more time positions for the WTRU to monitor for the first signal.

14. A network device, comprising:
a processor configured to:
transmit a first signal to a wireless transmit/receive unit (WTRU) while the WTRU is in a discontinuous reception (DRX) mode, wherein the first signal indicates whether the WTRU is to monitor for a second signal associated with a power consumption that is higher than a power consumption associated with the first signal; and
on a condition that the first signal indicates that the WTRU is to monitor for the second signal:
transmit the second signal to the WTRU while the WTRU is in the DRX mode, wherein the second signal indicates that the WTRU is to monitor for downlink control information (DCI); and
transmit the DCI to the WTRU.

15. (canceled)

16. The network device of claim 14, wherein the first signal is associated with a first WTRU group that includes the WTRU, wherein the second signal is associated with a second WTRU group that includes the WTRU, and wherein the first WTRU group includes more WTRUs than the second WTRU group.

17. The network device of claim 14, wherein the first signal is transmitted to a WTRU group comprising the WTRU, and wherein the second signal is transmitted specifically to the WTRU.

18. The network device of claim 14, wherein the processor is further configured to transmit, to the WTRU, configuration information that indicates one or more time positions for the WTRU to monitor for the first signal.

19. (canceled)

20. (canceled)

21. The WTRU of claim 1, wherein the first signal and the second signal are wake-up signals associated with the DRX mode and are transmitted while the WTRU is a radio resource control (RRC) connected state.

22. The WTRU of claim 1, wherein the receiver activated for receiving the second signal is a main receiver of the WTRU.

23. The method of claim 9, wherein, based on a determination that the first signal has not been received or that the first signal includes no indication for the WTRU to monitor for the second signal, the method further comprises sleeping through a subsequent DRX on duration, and wherein, based on a determination that the second signal has not been received or that the second signal includes no indication for the WTRU to monitor for the DCI, the method further comprises sleeping through a subsequent DRX on duration.

24. The method of claim 9, wherein the DRX mode is entered while the WTRU in a radio resource control (RRC) connected state.

25. The method of claim 9, wherein at least one of the first signal or the second signal is a wake-up signal associated with the DRX mode.

26. The method of claim 9, wherein the receiver activated for receiving the second signal is a main receiver of the WTRU.
